(19) United States
(12) Patent Application Publication
(10) Pub. No.: US 2013/0046669 A1
(43) Pub. Date: Feb. 21, 2013

(54) Gas cost calculator

(71) Applicant: Earl Harris, Owings, MD (US)

(72) Inventor: Earl Harris, Owings, MD (US)

(21) Appl. No.: 13/586,320

(22) Filed: Aug. 15, 2012

Related U.S. Application Data
(60) Provisional application No. 61/575,154, filed on Aug. 15, 2011.

(51) Int. Cl. G06Q 40/00

(52) U.S. Cl. 705/35

(57) ABSTRACT

A gas cost calculator comprising a display screen, a keypad, a central programming unit, and cable capable of receiving digital input from the gas gauge of a vehicle, said central programming unit programmed with algorithms used to calculate cost needed to fill a gas tank of the vehicle with gas based on a price input into the keypad by the user. This gas cost calculator is an automotive accessory intended to aid motorist in determining cost to fill the vehicle's gas tank.

### CROSS-REFERENCE TO RELATED APPLICATIONS

The present application claims priority under 35 USC 119(e) (1) from U.S. Provisional Patent Application Ser. Number 61/575,154 filed Aug. 15, 2011, of common inventorship, herewith entitled “Digital Cost Read-Out”.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention pertains to the field of automobile accessories, and more specifically to the field of assistive electronic devices for calculating fuel costs.

### BACKGROUND OF THE INVENTION

The prior art has put forth several designs for assistive devices in calculating fuel costs. Among these are:

U.S. Pat. No. 6,070,156 to Hal Craig Hartsell Jr. describes a vehicle mounted transponder operatively associated with vehicle control system and a vehicle's fuel tank in a manner to receive and determine information relating to fuel tank usage. The usage information includes fuel amount required to fill a tank, tank size and quantity currently in a tank and is used in calculating the cost in filling a tank.

U.S. Pat. No. 4,350,880 to Bartholomew F. Quintilian describes a system for budgeting fuel costs and emitting an unwarranted cost alarm based on instantaneous consumption in a motor vehicle using liquid, gaseous, solid or electrical fuel. The system includes an input drive to a counting meter showing monetary accumulation of fuel costs based on engine efficiency and variables of estimated miles per unit of fuel. The system is connected to a vehicle's odometer for calculating fuel usage and resetting cost and meter back to zero after filling a tank with fuel.

U.S. Pat. No. 4,100,400 to John A. Callahan and Allan S. Ottenstein describes a highly accurate price encoder for delivering pulses corresponding to the price of gasoline or other liquid petroleum products dispensed by a pump. The encoder is used with a wide variety of existing price computers and removably mounted on the computer. This encoder includes an input gear for engaging a drive gear on the computer. A pulse generator coupled to the input gear provides pulses at a higher rate than required for output, and a counter reduces this pulse rate to provide a desired number of pulses per unit price. This counter is reset each time operating power is applied, to eliminate errors that might arise when the pump is reset.

None of these prior art references describe the present invention.

### SUMMARY OF THE INVENTION

It is an object of the present invention to provide a digital gas cost calculator readout device for automobiles.

### BRIEF DESCRIPTION OF THE DRAWINGS

FIG. 1 is a top perspective view of a handheld version of the present invention illustrating a touch screen with a digital data display and a keypad for data entry and calculations.

FIG. 2 is a front illustrative view of the present invention installed in a vehicle's dash area.

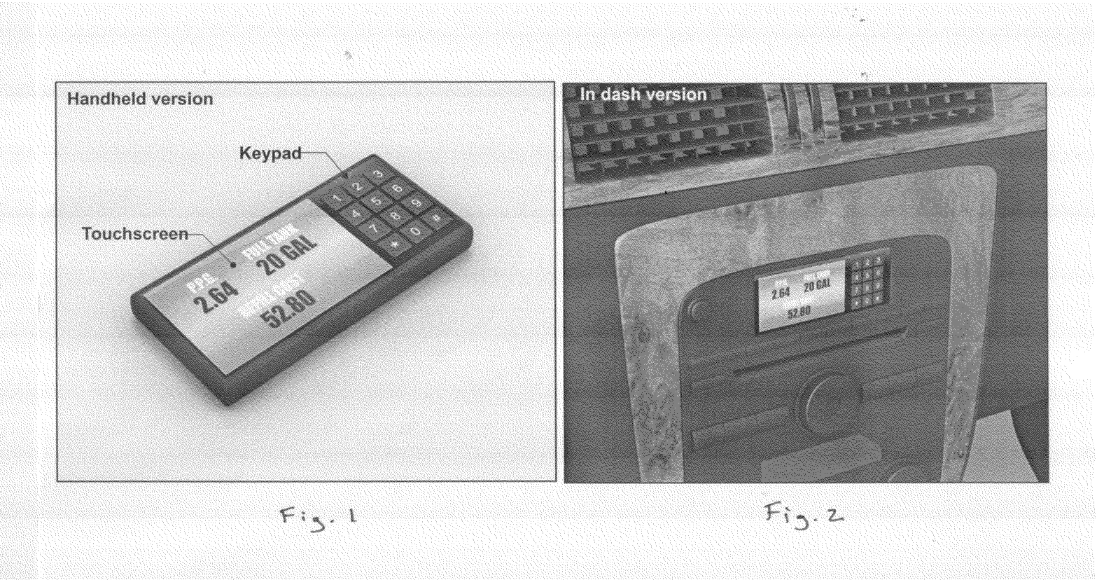

### DETAILED DESCRIPTION OF THE INVENTION

Everyday millions of drivers climb into their cars, trucks or minivans and make their way across the highways and byways of their respective countries. Whether a retired couple embarking on a cross country journey, a college coed enduring a long commute to school or a busy homemaker driving a few blocks to a neighborhood grocer, automobiles offer consumers a simple way in which to get from one place to another, both safely and easily. Steep increases in gasoline prices have influenced many consumers to out back on driving, yet fuel is a continuing and constant requirement for motorists.

The present invention, hereinafter referred to as the Digital Cost Read-Out, is an electronic calculating device for automobiles that is specially designed to provide a digital reading of the cost of a full tank of gas based on the price at a particular pump. The gas cost calculator comprises a display screen, a keypad, a central programming unit and cable capable of receiving digital input from the gas gauge of a vehicle, with said central programming unit programmed with algorithms used to calculate cost needed to fill a gas tank of the vehicle with gas based on a price input into the keypad by the user. The Digital Cost Read-Out is a compact rectangular unit that may be integrally connected with a vehicle's gas gauge and positioned inside the vehicle on the instrument panel. The exterior of the Digital Cost Read-Out composes a liquid crystal display or LCD screen that conveys the gas price and the total cost of a full tank of gas. The present invention contains a numeric keypad to enable a user to input a price per gallon into a calculator. When a motorist's vehicle contains less than a quarter tank of gas, the motorist pulls up to a selected fuel pump, reads a price per gallon displayed on the pump for a specific grade of fuel, and inputs this price per gallon into the Digital Cost Read-Out. Based on the gas gauge and size of a car's gas tank, the present invention determines how many gallons are needed to fill the vehicle's tank. If a vehicle requires approximately sixteen gallons, the unit multiplies sixteen by specific embodiments, it is not intended to be limited thereto and various modifications which will become apparent to the person of ordinary skill in the art are intended to fall within the spirit and scope of the invention as described herein taken in conjunction with the accompanying drawings and the appended claims.

I claim:

1. A gas cost calculator comprising a display screen, a keypad, a central programming unit, and cable capable of receiving digital input from the gas gauge of a vehicle, said central programming unit programmed with algorithms used to calculate cost needed to fill a gas tank of the vehicle with gas based on a price input into the keypad by the user.
